(19) United States
(12) Patent Application Publication
(10) Pub. No.: US 2012/0077369 A1
(43) Pub. Date: Mar. 29, 2012

(54) SYSTEMS, METHODS, AND APPARATUS FOR PROVIDING A BRANCH WIRING CONNECTOR

(75) Inventor: Ryan Andersen, Williamsport, PA (US)

(73) Assignee: ALCAN PRODUCTS CORPORATION, Atlanta, GA (US)

(21) Appl. No.: 12/892,512

(22) Filed: Sep. 28, 2010

(51) Int. Cl. H01R 13/64; H01R 3/00

(52) U.S. Cl. 439/488; 439/680

(57) ABSTRACT

Embodiments of the invention relate to systems, methods, and apparatus for providing a branch wiring connector. connector. In one embodiment, a branch wiring connector system can be provided. The branch wiring connector can include a first housing and a second housing, which can include a plurality of hole projections with a key shape, and at least one conductor pin retaining device operable to maintain the position of a least one conductor pin and associated wire when the at least one conductor pin is inserted into at least one of the plurality of first housing hole projections. The second housing can include a plurality of second housing holes, which can include a plurality of second housing holes with a key receiver which corresponds with the key shape, and at least one conductor pin receiver retaining device operable to maintain the position of at least one conductor pin receiver and associated wire when the at least one conductor pin receiver is inserted into at least one of the plurality of second housing holes.

### TECHNICAL FIELD

The invention relates generally to connectors, and more particularly to systems, methods, and apparatus for providing a branch wiring connector.

### BACKGROUND OF THE INVENTION

Generally, electrical wiring installation in a building can include one or more circuits to deliver electrical service to various areas of the building, such as to electrical outlets installed at an associated electrical junction boxes. Each of the circuits can be a branch circuit, which can originate at a centralized service distribution panel. When the building is initially wired for electrical service, one or more electrical contractors and workers can route electrical wires between the service distribution panel and the electrical junction boxes. At the electrical junction boxes and the service distribution panel, an electrical contractor or worker must, in certain instances, connect the routes electrical wires to wires associated with an electrical outlet at the electrical junction box or a circuit breaker or other fuse at the service distribution panel to complete the branch circuit.

A variety of conventional electrical accessories can be used with electrical wiring to assist an electrical contractor or worker in wiring a branch circuit. For instance, conventional electrical accessories can include single wire connectors, wire nuts, crimp slices, push-in splices, and screw-in splices, among others. However, conventional electrical accessories can be relatively time consuming and/or expensive for electrical contractors and workers to install. For example, wire nut and push-in connectors may be used by some electrical contractors or workers to complete the wiring of branch circuits. However, over time, such electrical contractors and workers may experience repetitive motion injuries after installing numerous wire nut and push-in connectors.

In certain instances, conventional multiphase connectors, such as those shown respectively as 100, 200 in FIGS. 1 and 2, can be used by electrical contractors and workers to complete the wiring of branch circuits. Example conventional pin connectors used with these conventional multiphase connectors are shown as 300, 400 in FIGS. 3 and 4. However, electrical contractors and workers may mis-wire one or more circuits using such conventional multiphase connectors and associated pin connectors. One cause of such mis-wiring may be mismatched branch circuit wiring. In other instances, such conventional multiphase connectors and/or pin connectors may not be compliant with certain applicable standards, such as UL 2459, entitled “UL Standard for Safety for Insulated Multi-Pole Splicing Wire Connectors,” published by the Underwriters Laboratories, Inc. (1^{st} ed. dated Aug. 22, 2008) or other UL listing requirements.

### SUMMARY OF THE INVENTION

Embodiments of the invention can provide some or all of the above needs. Certain embodiments of the invention can provide systems, methods, and apparatus for providing a branch wiring connector. In one embodiment, a branch wiring connector system can be provided. The branch wiring connector can include a first housing and a second housing. The first housing can include a plurality of first housing hole projections operable to receive respective conductor pins and associated conductor wires, wherein at least one of the plurality of hole projections can include a key shape; and at least one conductor pin retaining device operable to maintain the position of a least one conductor pin and associated wire when the at least one conductor pin is inserted into at least one of the plurality of first housing hole projections. The second housing can include a plurality of second housing holes operable to receive respective conductor receivers and associated conductor wires, wherein the plurality of second housing holes correspond with the plurality of first housing hole projections, and wherein at least one of the plurality of second housing holes can include a key receiver which corresponds with the key shape; and at least one conductor pin receiver retaining device operable to maintain the position of at least one conductor pin receiver and associated wire when the at least one conductor pin receiver is inserted into at least one of the plurality of second housing holes. Furthermore, the first housing and second housing mount together to facilitate mounting the conductor pins to respective conductor pin receivers when the plurality of first housing hole projections are in correspondence with the plurality of second housing holes.

In one aspect of an embodiment, the key shape can include one of the following: a teardrop shape, or a protrusion.

In one aspect of an embodiment, the system meets or exceeds at least one of the following UL listing requirements: short-time withstand current, latching mechanism, abnormal overload, temperature rise, dielectric voltage withstand, dielectric withstand—puncture, mold stress relief, current cycling, mechanical sequence, spring action, or any UL listing requirement specified under UL 2459.

In one aspect of an embodiment, the first housing or the second housing fits within a standard ½ inch size knockout of an electrical junction box.

In one aspect of an embodiment, the first housing and the second housing can include one or more of the following to facilitate mounting the first housing and second housing together: color codes, tactile indicators, or visual cues.

In one aspect of an embodiment, the at least one conductor pin retaining device or the at least one conductor pin receiver retaining device can include a restrictor section mounted within a respective first mounting hole or second mounting hole, wherein the restrictor section engages one or more protrusions from the respective conductor pin or conductor pin receiver.

In one aspect of an embodiment, the system can further include a conductor pin operable to mount to an end of a first electrical conductor, and further operable to be inserted into at least one of the plurality of first housing hole projections; and a conductor pin receiver operable to mount to an end of a second electrical conductor, and further operable to be inserted into at least one of the plurality of second housing holes, wherein the conductor pin and conductor pin receiver mount together when the first housing and second housing are mounted together and the plurality of first housing hole projections are in correspondence with the plurality of second housing holes.

In one aspect of an embodiment, the first housing can further include an engagement device complementary with a corresponding engagement device of the second housing, wherein when the first housing and second housing are mounted together in close proximity the engagement device of the first housing and corresponding engagement device of the second housing maintain the respective positions of the first housing and second housing.

In another embodiment, a method for connecting conductors in a branch wiring circuit can be provided. The method can include providing a first housing. The first housing can include a plurality of first housing hole projections operable to receive respective conductor pins and associated conductor wires, wherein at least one of the plurality of first housing hole projections can include a key shape; at least one conductor pin retaining device operable to maintain the position of a least one conductor pin and associated wire when the at least one conductor pin is inserted into at least one of the plurality of first housing hole projections. The method can also include providing a second housing. The second housing can include a plurality of second housing holes operable to receive respective conductor receivers and associated conductor wires, wherein the plurality of second housing holes correspond with the plurality of first housing hole projections, and wherein at least one of the plurality of second housing holes can include a key receiver which corresponds with the key shape; and at least one conductor pin receiver retaining device operable to maintain the position of at least one conductor pin receiver and associated wire when the at least one conductor pin receiver is inserted into at least one of the plurality of second housing holes. The method can further include aligning the plurality of first housing hole projections with the plurality of second housing holes, wherein the key shape aligns with the key receiver. Furthermore, the method can include mounting the first housing and second housing together to facilitate mounting the conductor pins to respective conductor pin receivers.

In one aspect of an embodiment, a key shape which can include one of the following: a teardrop shape, or a protrusion.

In one aspect of an embodiment, the method can further include inserting the first housing or the second housing within a standard ½ inch size knockout of an electrical junction box.

In one aspect of an embodiment, the first housing and the second housing can include one or more of the following to facilitate mounting the first housing and second housing together: color codes, tactile indicators, or visual cues.

In one aspect of an embodiment, the at least one conductor pin retaining device or the at least one conductor pin receiver retaining device can include a restrictor section mounted within a respective first mounting hole or second mounting hole, wherein the restrictor section engages one or more protrusions from the respective conductor pin or conductor pin receiver.

In one aspect of an embodiment, the method can further include providing a conductor pin operable to mount to an end of a first electrical conductor, and further operable to be inserted into at least one of the plurality of first housing hole projections; and providing a conductor pin receiver operable to mount to an end of a second electrical conductor, and further operable to be inserted into at least one of the plurality of second housing holes, wherein the conductor pin and conductor pin receiver mount together when the first housing and second housing are mounted together and the plurality of first housing hole projections are in correspondence with the plurality of second housing holes.

In one aspect of an embodiment, the first housing further can include an engagement device complementary with a corresponding engagement device of the second housing, wherein when the first housing and second housing are mounted together in close proximity the engagement device of the first housing and corresponding engagement device of the second housing maintain the respective positions of the first housing and second housing.

In another embodiment, an electrical connector system can be provided. The electrical connector system can include a first housing and a second housing. The first housing can include a plurality of first housing hole projections operable to receive respective conductor pins and associated conductor wires, wherein at least one of the plurality of first housing hole projections can include a key shape comprising one of the following: a teardrop shape, or a protrusion. The first housing can also include at least one conductor pin retaining device operable to maintain the position of a least one conductor pin and associated wire when the at least one conductor pin is inserted into at least one of the plurality of first housing hole projections. The second housing can include a plurality of second housing holes operable to receive respective conductor receivers and associated conductor wires, wherein the plurality of second housing holes correspond with the plurality of first housing hole projections, and wherein at least one of the plurality of second housing holes can include a key receiver which corresponds with the key shape. The second housing can include at least one conductor pin receiver retaining device operable to maintain the position of at least one conductor pin receiver and associated wire when the at least one conductor pin receiver is inserted into at least one of the plurality of second housing holes, wherein the first housing and second housing mount together when the plurality of first housing holes are in correspondence with the plurality of second housing holes. The electrical connector system can also include a conductor pin operable to mount to an end of a first electrical conductor, and further operable to be inserted into at least one of the plurality of first housing hole projections. Furthermore, the electrical connector system can include a conductor pin receiver operable to mount to an end of a second electrical conductor, and further operable to be inserted into at least one of the plurality of second housing holes, wherein the conductor pin and conductor pin receiver mount together when the first housing and second housing are mounted together and the plurality of first housing hole projections are in correspondence with the plurality of second housing holes.

In one aspect of an embodiment, the system meets or exceeds at least one of the following UL listing requirements: short-time withstand current, latching mechanism, abnormal overload, temperature rise, dielectric voltage withstand, dielectric withstand—puncture, mold stress relief, current cycling, mechanical sequence, spring action, or any UL listing requirement specified under UL 2459.

In one aspect of an embodiment, the first housing or the second housing fits within a standard ½ inch size knockout of an electrical junction box.

In one aspect of an embodiment, the first housing and the second housing can include one or more of the following to facilitate mounting the first housing and second housing together: color codes, tactile indicators, or visual cues.

In one aspect of an embodiment, the first housing can further include an engagement device complementary with a corresponding engagement device of the second housing, wherein when the first housing and second housing are mounted together in close proximity the engagement device of the first housing and corresponding engagement device of the second housing maintain the respective positions of the first housing and second housing.

In yet another embodiment, a branch wiring connector system can be provided. The branch wiring connector system can include a first housing. The first housing can include a plurality of first housing hole projections operable to receive respective conductor wires, wherein at least one of the plurality of first housing hole projections comprises a first housing code. The first housing can also include at least one conductor wire retaining device operable to maintain the position of a least one conductor wire when the at least one conductor wire is inserted into at least one of the plurality of first housing hole projections. The branch wiring connector system can also include a second housing. The second housing can include a plurality of second housing holes operable to receive other respective conductor wires, wherein the plurality of second housing holes correspond with the plurality of first housing holes, and wherein at least one of the plurality of second housing holes comprises a second housing code which corresponds with the first housing code, wherein the first housing and second housing mount together to facilitate mounting the conductor wires to the other respective conductor wires when the plurality of first housing hole projections are in correspondence with the plurality of second housing holes.

Other systems, processes, aspects, and features according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIGS. 1-4 illustrate conventional multiphase connectors and associated pin connectors.

FIG. 5 illustrates an example system and apparatus according to an embodiment of the invention.

FIG. 6 illustrates an example system and apparatus in a closed or connected orientation according to an embodiment of the invention.

FIG. 7 illustrates the example system and apparatus of FIG. 6 in an open or disconnected orientation according to an embodiment of the invention.

FIG. 8 illustrates an example male portion of the apparatus shown in FIG. 5.

FIG. 9 illustrates a side sectional view of the apparatus shown in FIG. 8.

FIG. 10 illustrates detail view A of the apparatus shown in FIG. 9.

FIG. 11 illustrates an example female portion of the apparatus shown in FIG. 5.

FIG. 12 illustrates a side sectional view of the apparatus shown in FIG. 8.

FIG. 13 illustrates another view of the apparatus shown in FIG. 8

FIG. 14 illustrates a detail view E of the apparatus shown in FIG. 8

FIG. 15 illustrates example pin connectors shown in FIG. 5 according to an embodiment of the invention.

FIG. 16 illustrates a female portion of the example pin connector shown in FIG. 15.

FIG. 17 illustrates a male portion of the example pin connector shown in FIG. 15.

FIG. 18 illustrates another example set of pin connectors according to an embodiment of the invention.

FIG. 19 illustrates another example system and apparatus according to an embodiment of the invention.

FIGS. 20-21 illustrate other views of the example system and apparatus shown in FIG. 19.

FIGS. 22-25 illustrate another example system and apparatus according to an embodiment of the invention.

FIG. 26 illustrates a flowchart of an example method according to one embodiment of the invention.

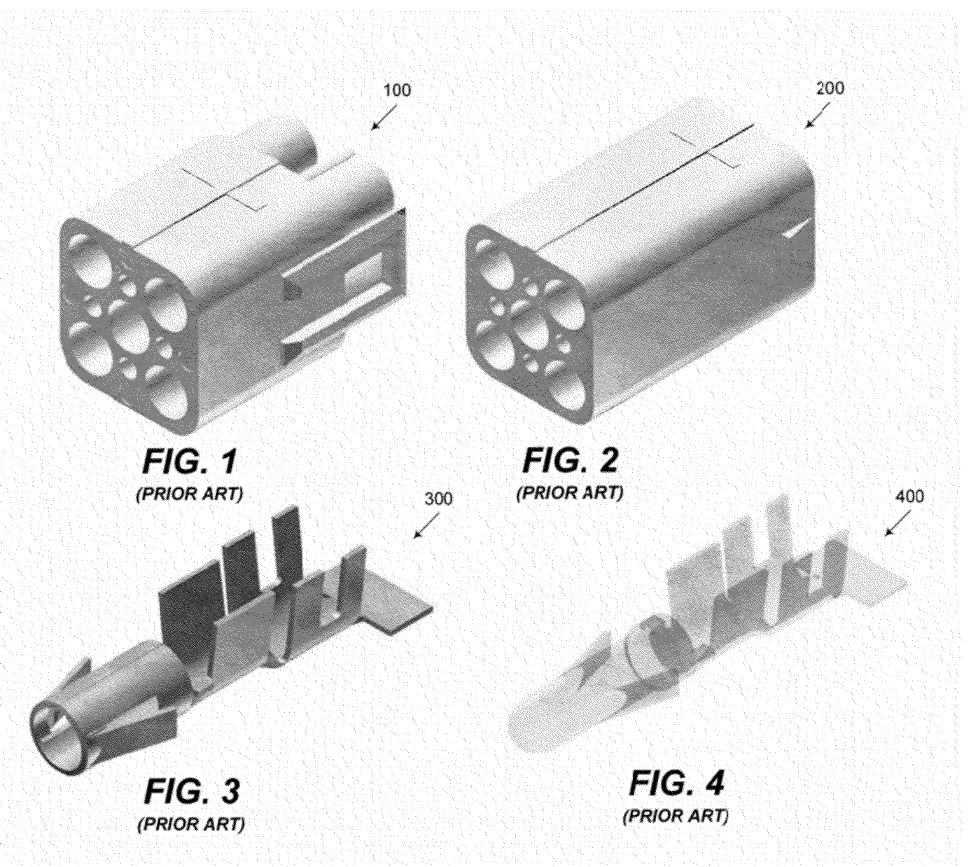

### DETAILED DESCRIPTION OF EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

Certain embodiments of the invention generally provide for systems, methods, and apparatus for providing a branch wiring connector. Because a branch wiring circuit can be implemented, using various systems, methods, and apparatus according to embodiments of the invention, such embodiments can result in decreased installation costs. In addition, technical effects by certain embodiments of the invention can result such as reducing the temperature rise of the branch wiring connector while in use, yet maintaining a relatively compact, multi-pin connector configuration. Furthermore, technical effects by certain embodiments of the invention can result such as the ability to avoid mis-wiring problems when installing components for a branch wiring circuit. One technical result of certain embodiments of the invention is the ability to improve conductivity in a branch wiring connector while maintaining a relatively compact, multi-pin connector configuration. Another technical result of certain embodiments of the invention is the ability to consistently and correctly match up and connect electrical wires or conductors in a branch wiring circuit. One should appreciate that certain embodiments of the invention can be used in other environments, contexts, and applications, and should not be limited to branch wiring applications or applications, but should include non-branch wiring applications and applications in which one or more wires or conductors are connected to each other.

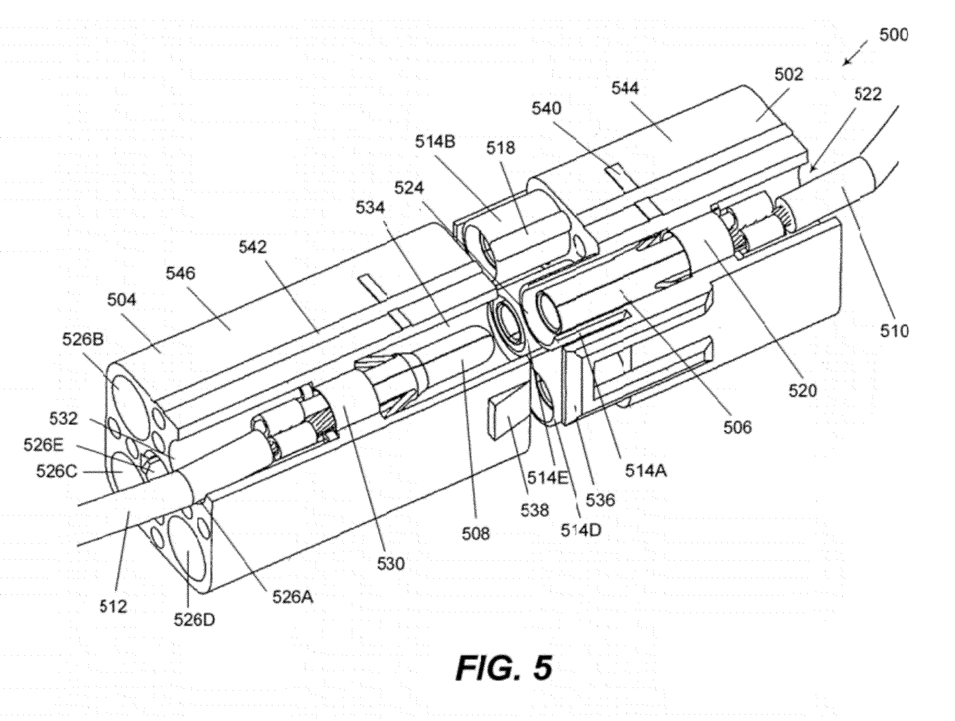

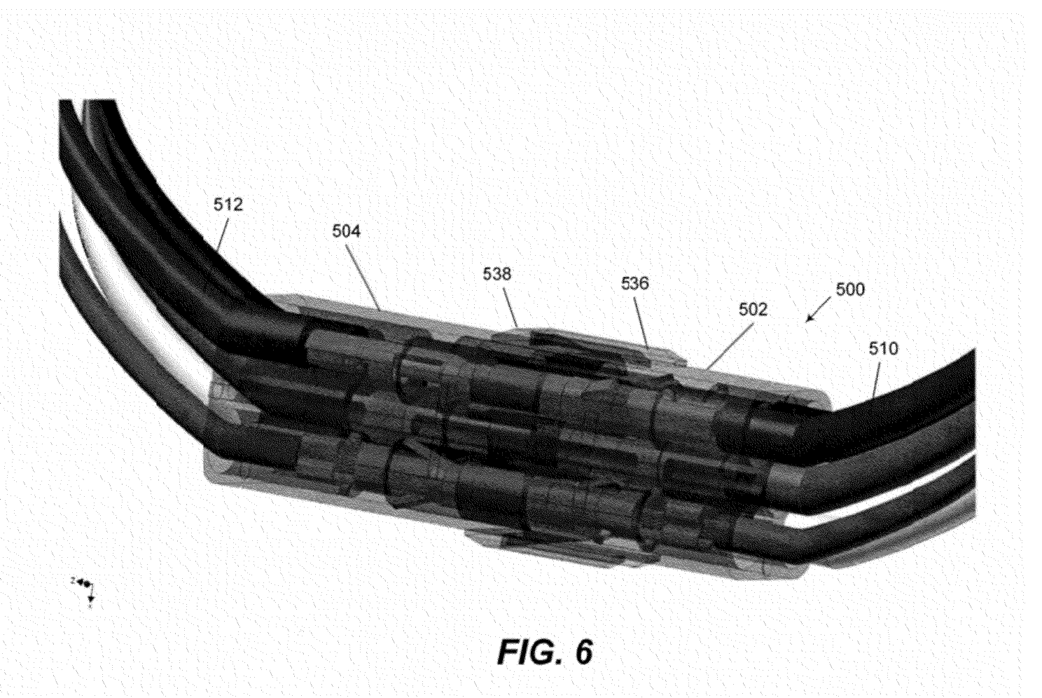

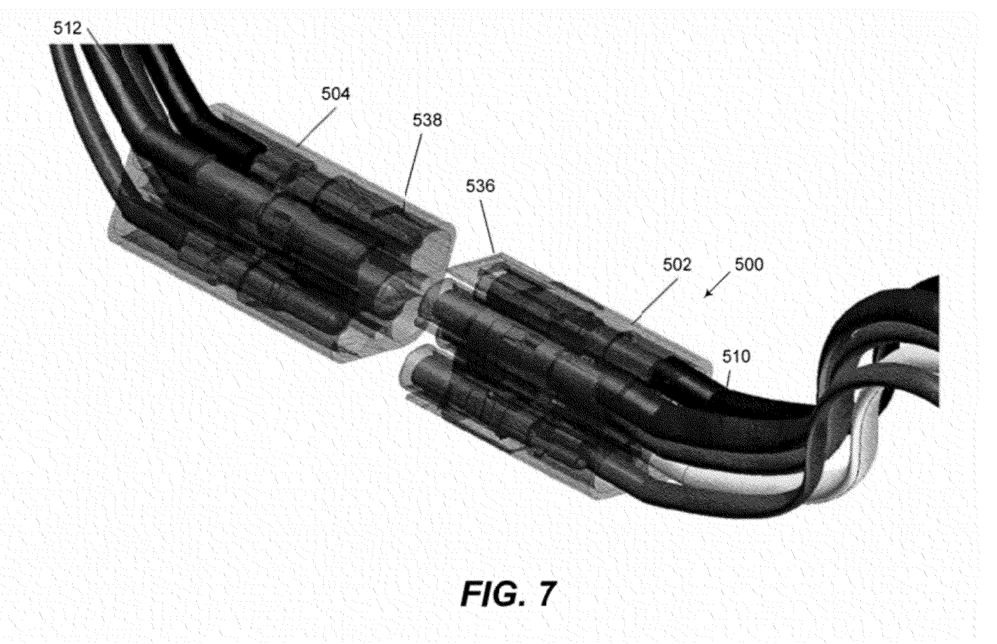

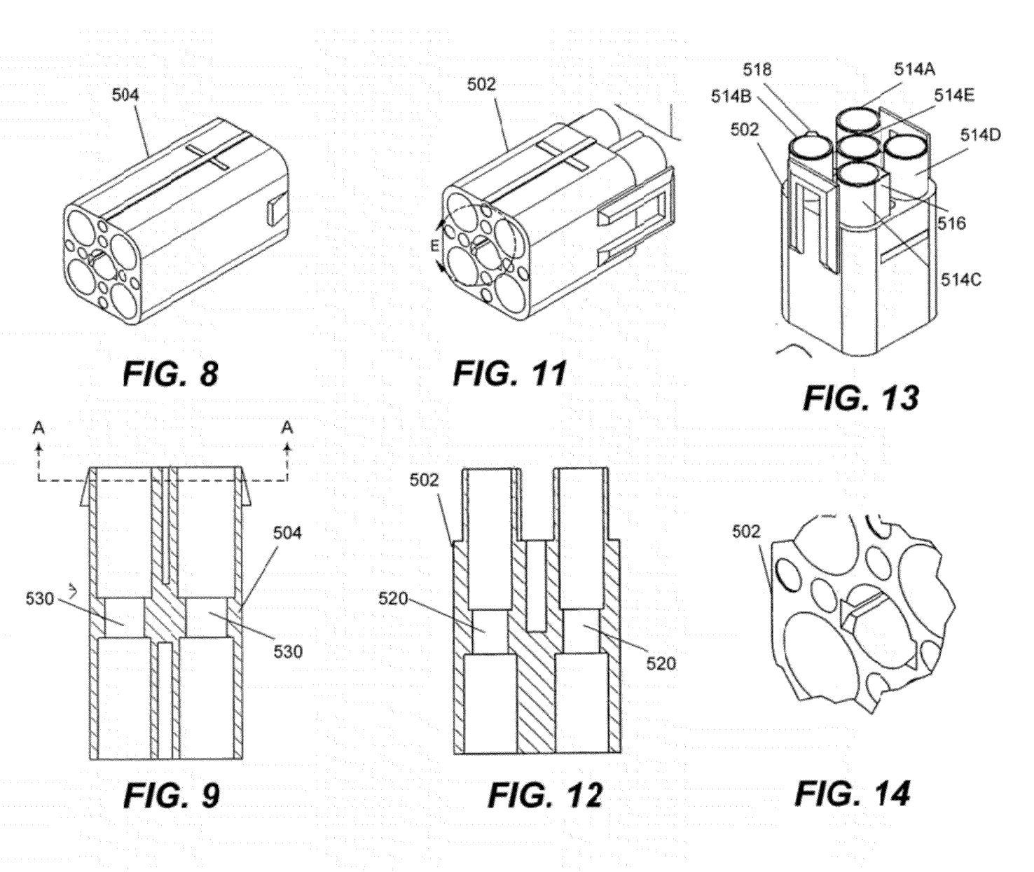

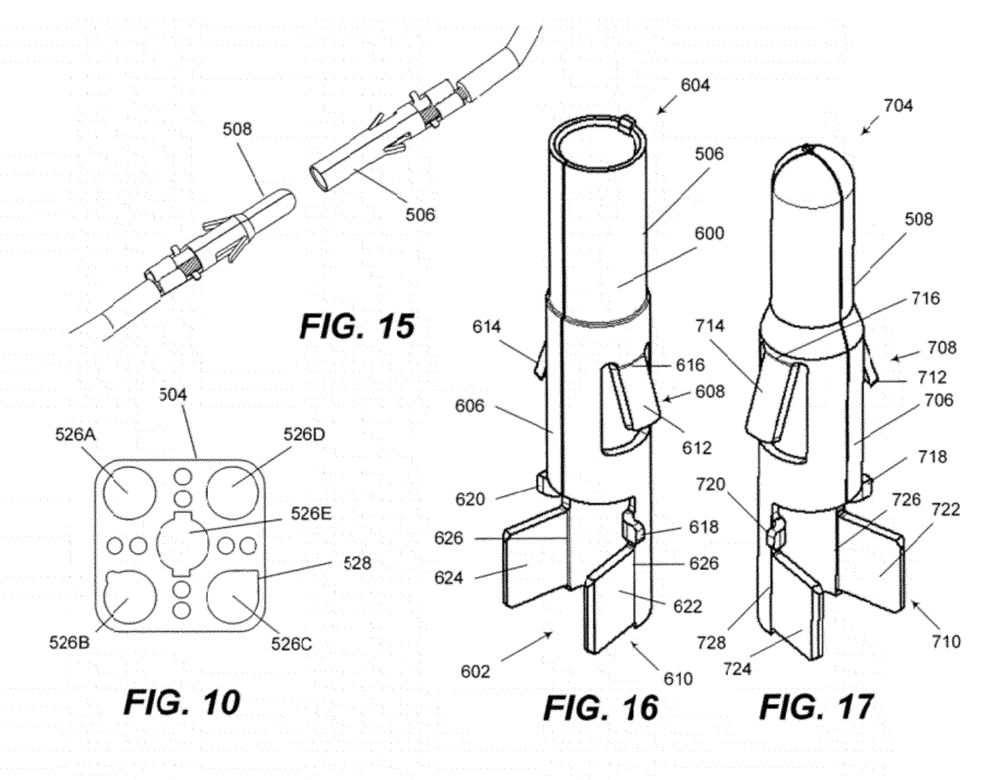

FIGS. 5-17 illustrate various views of example systems and/or apparatus in accordance with an embodiment of the invention. FIG. 5 illustrates an example system, such as a branch wiring connector system, and apparatus, such as a set of conductor pins, in accordance with an embodiment of the invention. As shown in FIG. 5, a branch wiring connector system 500 can include a first housing 502 and a second housing 504, and the set of conductor pins can include a first conductor pin 506 and a second conductor pin 508. The first conductor pin 506 can mount to a corresponding wire or conductor, such as 510, and the second conductor pin 508 can mount to another corresponding wire or conductor, such as 512. Shown in a partial assembled view in FIG. 5, the conductor pins 506, 508 are mounted within respective portions of the first housing 502 and second housing 504, shown in an aligned orientation. When the first housing 502 and second housing 504 are mounted together, in a closed or connected orientation as shown in FIG. 6, the first conductor pin 506 mounts to the second conductor pin 508 to facilitate completion of a branch wiring circuit. In other embodiments, other conductor pins can be mounted within other respective portions of the first housing 502 and second housing 504, and can be mounted together when the first housing 502 and second housing 104 are mounted together to further facilitate completion of a branch wiring circuit. FIGS. 6 and 7 illustrate embodiments with multiple conductor pins mounted within respective portions of a first housing 502 and second housing 504, wherein FIG. 6 shows the housings in a closed or connected orientation, and FIG. 7 shows the housings in an open or disconnected orientation.

The first housing 502 shown in FIGS. 5 and 11-14 is a male portion of the branch wiring connector system 500. The first housing 502 in this example embodiment has a rectangular-shaped body and can include one or more first housing hole projections 514A-514E operable to receive respective conductor pins, such as 506, and associated conductor wires, such as 510. In the embodiment shown, at least one of the first housing hole projections, such as 514A, can include a unique key shape. In this example, two of the first housing hole projections, such as 514A and 514B, can have unique shapes, including a teardrop shape 516 and a projection shape 518, as seen in FIG. 13. In any instance, the unique shapes of the first housing hole projections, such as 514A and 514B, can be uniquely shaped and/or sized to correspond with particular respective holes in the second housing 504 of the branch wiring connector system 500.

The first housing 502 shown in FIGS. 5 and 11-14 can include one or more conductor pin retaining devices, such as 520. Each conductor pin retaining device 520 is operable to maintain the position a conductor pin, such as 506, and associated conductor wire, such as 510, when the conductor pin 506 is inserted into a housing hole projection, such as 514A. In the embodiment shown, the conductor pin retaining device 520 is a restriction or collar-shaped device positioned approximately midway between opposing openings 522, 524 of the first housing hole projection 514A. When a conductor pin, such as 506, is inserted into the opening 522 of the first housing hole projection 514A, and the conductor pin 506 is inserted a suitable distance into the first housing hole projection 514A and into the conductor pin retaining device 520, the conductor pin retaining device 520 can prevent or otherwise inhibit the conductor pin 506 from being withdrawn from the same opening 522. In any instance, the conductor pin retaining device 520 can maintain the position of the conductor pin 506 within the first housing hole projection 514A.

The second housing 504 in the example embodiment of FIGS. 5 and 8-10 has a rectangular-shaped body and can include one or more second housing holes, such as 526A-526E. The second housing holes 526A-526E are operable to receive respective conductor pin receivers, such as 508, and associated conductor wires, such as 512, wherein the second housing holes 526A-526E correspond with the plurality of first housing hole projections, such as 514A-514E. In the embodiment shown, at least one of the second housing holes, such as 526A, can include a key receiver 528 which corresponds with the unique key shape, such as 516, of a first housing hole projection, such as 514A.

The second housing 504 can also include one or more conductor pin receiver retaining devices, such as 530. Each pin receiver retaining device 530 is operable to maintain the position of a conductor pin receiver, such as 508, and associated conductor wire, such as 512, when the conductor pin receiver 508 is inserted into a second housing hole, such as 526A. In the embodiment shown, the pin receiver retaining device 530 can be a restriction or collar-shaped device, similarly shaped as the conductor pin retaining device 520 of the first housing 502, and positioned approximately midway between opposing openings 532, 534 of the second housing hole 526A. When a conductor pin receiver, such as 508, is inserted into the second housing hole 526A, and the conductor pin receiver 508 is inserted a suitable distance into the opening 532 of the second housing hole 526A and into the pin receiver retaining device 530, the pin receiver retaining device 530 can prevent or otherwise inhibit the conductor pin receiver 508 from being withdrawn from the same opening 532. In any instance, the pin receiver retaining device 530 can cooperate with the pin receiver retaining device 530 to maintain the position of the conductor pin receiver 508 within the second housing hole 526A.

As shown in FIG. 5, the first housing 502 and second housing 504 can mount together to facilitate mounting one or more conductor pins, such as 506, to one or more respective conductor pin receivers, such as 108, when the first housing hole projections, such as 514A-514E, are in correspondence with one or more second housing holes, such as 526A-526E.

In one embodiment, the system 500 can include an apparatus, such as a conductor pin 508, operable to mount to an end of an electrical conductor or wire, such as 512, and further operable to be inserted into at least one of a plurality of housing holes, such as 526A-526E. The system 500 can also include another apparatus, such as a conductor pin receiver 506, operable to mount to an end of another electrical conductor or wire, such as 510, and further operable to be inserted into at least one of a plurality of housing hole projections, such as 514A-514E. In this manner, when the conductor pin 508 and conductor pin receiver 506 can be mounted together when the first housing 502 and second housing 504 are mounted together and the housing holes 526A-526E are in correspondence with the plurality of housing hole projections 514A-514E. The conductor pin 508 and conductor pin receiver 506 shown in FIG. 5 are described below in greater detail with respect to FIGS. 15-17.

In one aspect of an embodiment, the system 500 meets or exceeds at least one of the following UL listing requirements: short-time withstand current, latching mechanism, abnormal overload, temperature rise, dielectric voltage withstand, dielectric withstand—puncture, mold stress relief, current cycling, mechanical sequence, spring action, or any UL listing requirement specified under UL 2459. For example, in one embodiment, a system such as 500 can meet a UL 2459 requirement for maximum temperature rise when subjected to a certain electrical load.

In one aspect of an embodiment, a first housing, such as 502, or the second housing, such as 504, can fit within a standard ½ inch size knockout of an electrical junction box.

In one aspect of an embodiment, at least one conductor pin retaining device, such as 520, or at least one conductor pin receiver retaining device, such as 530, can include a restrictor section mounted within a respective first mounting hole projection, such as 514A-514E, or second mounting hole, such as 526A-526E, wherein the restrictor section engages one or more protrusions from the respective conductor pin, such as 508, or conductor pin receiver, such as 506.

In one aspect of an embodiment, a first housing, such as 502, can further include an engagement device, such as 536, complementary with a corresponding engagement device, such as 538, of a second housing, such as 504, wherein when the first housing 502 and second housing 504 are mounted together in close proximity the engagement device 536 of the first housing 502 and corresponding engagement device 538 of the second housing 504 can maintain the respective positions of the first housing and second housing.

In one aspect of an embodiment, a first housing, such as 502, and the second housing, such as 504, can include one or more of the following to facilitate mounting the first housing 502 and second housing 504 together: color codes, tactile indicators, or visual cues. For example, in the embodiment shown in FIG. 5, tactile indicators 540, 542 in the shape of a cross can be molded or otherwise formed on the upper lateral surfaces 544, 546 of the first housing 502 and second housing 504. Using the similar shaped tactile indicators 540, 542, a user or installer can quickly align the first housing 502 and second housing 504 to suitably align the respective first housing hole projections 514A-514E with the corresponding second housing holes 526A-526E. Though not illustrated, certain portions of a first housing, such as 502, and second housing, such as 504, can include color codes or other visual cues which can assist a user or installer to align the first housing 502 and second housing 504 to suitably align the respective first housing hole projections 514A-514E with the corresponding second housing holes 526A-526E.

FIG. 15 illustrates the example conductor pin 508 and conductor pin receiver 506 in an aligned orientation also shown in FIG. 5. FIG. 16 shows the example conductor pin receiver 506, and FIG. 17 shows the example conductor pin 508. As shown in FIG. 16, the conductor pin receiver 506 can include a cylindrical body 600 with a wire receiving end 602 and conductor pin receiving end 604. Between the ends 602, 604, a circumferentially-defined interface 606, a housing retention device 608, and a wire retention device 610 can be formed or otherwise mounted to the conductor pin receiver 506. At the circumferentially-defined interface 606, the diameter of the cylindrical body 600 decreases closer to the conductor pin receiving end 604 and the diameter of the cylindrical body 600 increases closer to the wire receiving end 602. Approximately midway between the ends 602, 604, the housing retention device 608 is shown with a pair of rectangular-shaped tab protrusions 612, 614 cut or otherwise formed on opposing lateral sides of the cylindrical body 600. The tab protrusions 612, 614 can laterally extend from the cylindrical body 600, and can flex at an interface 616 between respective tab protrusion 612, 614 and the cylindrical body 600. Adjacent to the wire receiving end 602, the wire retention device 610 can include a relatively small pair of short protrusions 618, 620, and a relatively larger pair of wide protrusions 622, 624 positioned closer to and immediately adjacent to the wire receiving end 602. Both sets of short protrusions 618, 620 and wide protrusions 622, 624 are cut or otherwise formed on opposing lateral sides of the cylindrical body 600, and extend from the cylindrical body 600 beginning approximately on laterally-oriented centerlines 626, 628 laterally bisecting the tab protrusions 612, 614.

The tab protrusions 612, 614 shown in FIG. 16 are generally rectangular in shape and are operable to extend outward from the cylindrical body 600. When the conductor pin receiver 506 is inserted into a housing, such as the first housing hole projection 514A of the first housing 502, the tab protrusions 612, 614 can be depressed inward towards the cylindrical body 600 to permit the tab protrusions 612, 614 to be inserted into and pass through the conductor pin retaining device, such as 520. Once the extended ends of the tab protrusions 612, 614 pass through the conductor pin retaining device 520, the tab protrusions 612, 614 can flex upward and away from the cylindrical body 600. In this manner, the tab protrusions 612, 614 can cooperate with the conductor pin retaining device 520 to maintain the position of the conductor pin receiver 506 within a first housing hole projection, such as 514A. When the conductor pin receiver 506 is moved in an opposite direction to withdraw the conductor pin receiver 506 from the conductor pin retaining device 520, the extended tab protrusions 612, 614 contact the conductor pin retaining device 520 and inhibit the withdrawal of the conductor pin receiver 506 from the conductor pin retaining device 520. When the tab protrusions 612, 614 are flexed inward towards the cylindrical body 600 to permit the tab protrusions 612, 614 to be reinserted into and pass through the conductor pin retaining device 520, the conductor pin receiver 506 can be withdrawn from the conductor pin retaining device 520 via the opposite direction.

The short protrusions 618, 620 shown in FIG. 16 are generally rectangular in shape and are operable to extend outward from the cylindrical body 600. When the conductor pin receiver 506 is inserted into a housing, such as the first housing hole projection 514A of the first housing 502, the short protrusions 618, 620 can be extended outward from the cylindrical body 600 to contact the conductor pin retaining device, such as 520. Once the extended ends of the tab protrusions 612, 614 pass through a conductor pin retaining device 520, the short protrusions 618, 620 remain on the other side of the conductor pin retaining device 520. In this manner, the short protrusions 618, 620 can cooperate with the conductor pin retaining device 520 to maintain the position of the conductor pin receiver 506 within a first housing hole projection, such as 514A. When the conductor pin receiver 506 is moved in the insertion direction towards the conductor pin retaining device 520, the short protrusions 618, 620 contact the conductor pin retaining device 520 and inhibit any further insertion or movement of the conductor pin receiver 506 into or within the first housing hole projection, such as 514A. Thus, both the tab protrusions 612, 614 and short protrusions 618, 620 of the conductor pin receiver 506 can cooperate to maintain the position of the conductor pin receiver 506 within the housing, such as the first housing hole projection 514A of the first housing 502.

The wide protrusions 622, 624 shown in FIG. 16 are generally rectangular in shape and are operable to extend outward from the cylindrical body 600. When the wire or conductor, such as 510, shown in this example as a two conductor wire, is inserted into the wire receiving end 602 of the conductor pin receiver 506, the wide protrusions 622, 624 can be flexed downward towards the cylindrical body 600 and conductor 510 and crimped over the conductor 510. In this manner, the wide protrusions 622, 624 can maintain the orientation of a wire or conductor, such as 510, with respect to the conductor pin receiver 506.

Turning to FIG. 17, the conductor pin 508 can include a cylindrical body 700 with a wire receiving end 702 and conductor pin receiver receiving end 704. Between the ends 702, 704, a circumferentially-defined interface 706, a pin housing retention device 708, and a wire retention device 710 can be formed or otherwise mounted to the conductor pin 508. At the circumferentially-defined interface 706, the diameter of the cylindrical body 700 decreases closer to the conductor pin receiver receiving end 704, and the diameter of the cylindrical body 700 increases closer to the wire receiving end 702. Approximately midway between the ends 702, 704, the pin housing retention device 708 is shown with a pair of rectangular-shaped tab protrusions 712, 714 cut or otherwise formed on opposing lateral sides of the cylindrical body 700. The tab protrusions 712, 714 can laterally extend from the cylindrical body 700, and can flex at an interface 716 between the respective tab protrusion 712, 714 and the cylindrical body 600. Adjacent to the wire receiving end 702, the wire retention device 710 can include a relatively small pair of short protrusions 718, 720, and a relatively larger pair of wide protrusions 722, 724 positioned closer to and immediately adjacent to the wire receiving end 702. Both sets of short protrusions 718, 720 and wide protrusions 722, 724 are cut or otherwise formed on opposing lateral sides of the cylindrical body 700, and extend from the cylindrical body 700 beginning approximately on laterally-oriented centerlines 726, 728 laterally bisecting the tab protrusions 712, 714.

The tab protrusions 712, 714 shown in FIG. 17 are generally rectangular in shape and are operable to extend outward from the cylindrical body 700. When the conductor pin 508 is inserted into a housing, such as the second housing hole 526A of the second housing 504, the tab protrusions 712, 714 can be depressed inward towards the cylindrical body 700 to permit the tab protrusions 712, 714 to be inserted into and pass through a conductor pin retaining device, such as 530. Once the extended ends of the tab protrusions 712, 714 pass through the conductor pin retaining device 530, the tab protrusions 712, 714 can flex upward and away from the cylindrical body 700. In this manner, the tab protrusions 712, 714 can cooperate with the conductor pin retaining device 530 to maintain the position of the conductor pin 508 within a second housing hole, such as 526A. When the conductor pin 508 is moved in an opposite direction to withdraw the conductor pin 508 from the conductor pin retaining device 530, the extended tab protrusions 712, 714 contact the conductor pin retaining device 530 and inhibit the withdrawal of the conductor pin 508 from the conductor pin retaining device 530. When the tab protrusions 712, 714 are flexed inward towards the cylindrical body 700 to permit the tab protrusions 712, 714 to be reinserted into and pass through the conductor pin retaining device 530, the conductor pin 508 can be withdrawn from the conductor pin retaining device 530 via the opposite direction.

The short protrusions 718, 720 shown in FIG. 17 are generally rectangular in shape and are operable to extend outward from the cylindrical body 700. When the conductor pin 508 is inserted into a housing, such as the second hole 526A of the second housing 504, the short protrusions 718, 720 can be extended outward from the cylindrical body 700 to contact the conductor pin retaining device, such as 530. Once the extended ends of the tab protrusions 712, 714 pass through the conductor pin retaining device 530, the short protrusions 718, 720 remain on the other side of the conductor pin retaining device 530. In this manner, the short protrusions 718, 720 can cooperate with the conductor pin retaining device 530 to maintain the position of the conductor pin 508 within a second housing hole, such as 526A. When the conductor pin 508 is moved in the insertion direction towards the conductor pin retaining device 530, the short protrusions 718, 720 contact the conductor pin retaining device 530 and inhibit any further insertion or movement of the conductor pin 508 into or within the second housing hole, such as 526A. Thus, both the tab protrusions 712, 714 and short protrusions 718, 720 of the conductor pin 508 can cooperate to maintain the position of the conductor pin 508 within the housing, such as the second housing hole 526A of the second housing 504.

The wide protrusions 722, 724 shown in FIG. 17 are generally rectangular in shape and are operable to extend outward from the cylindrical body 700. When the wire or conductor, such as 512, shown in this example as a two conductor wire, is inserted into the wire receiving end 702 of the conductor pin 508, the wide protrusions 722, 724 can be flexed downward towards the cylindrical body 700 and conductor 512 and crimped over the conductor 512. In this manner, the wide protrusions 722, 724 can maintain the orientation of a wire or conductor, such as 512, with respect to the conductor pin 508.

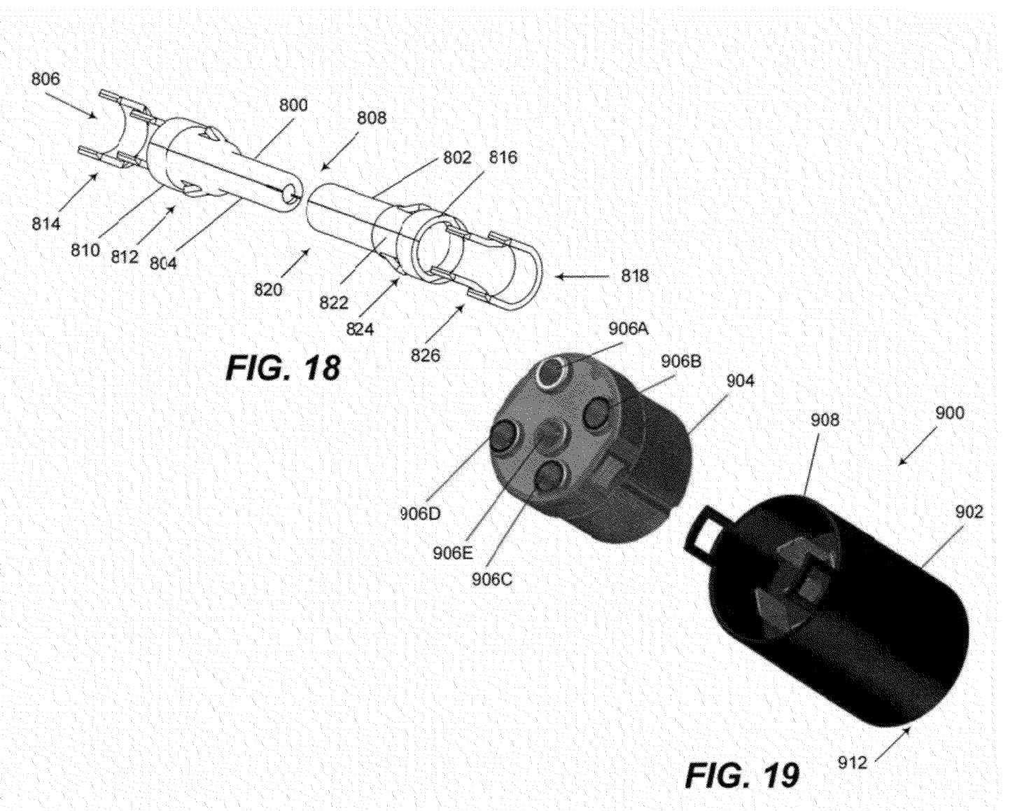

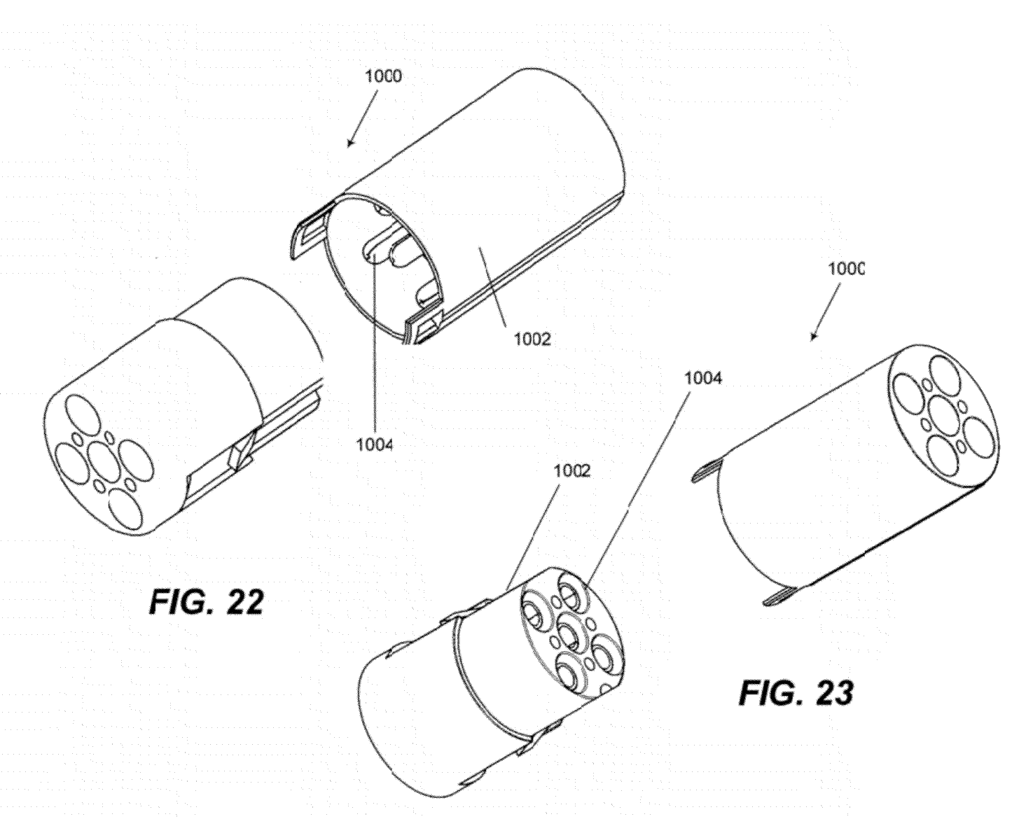

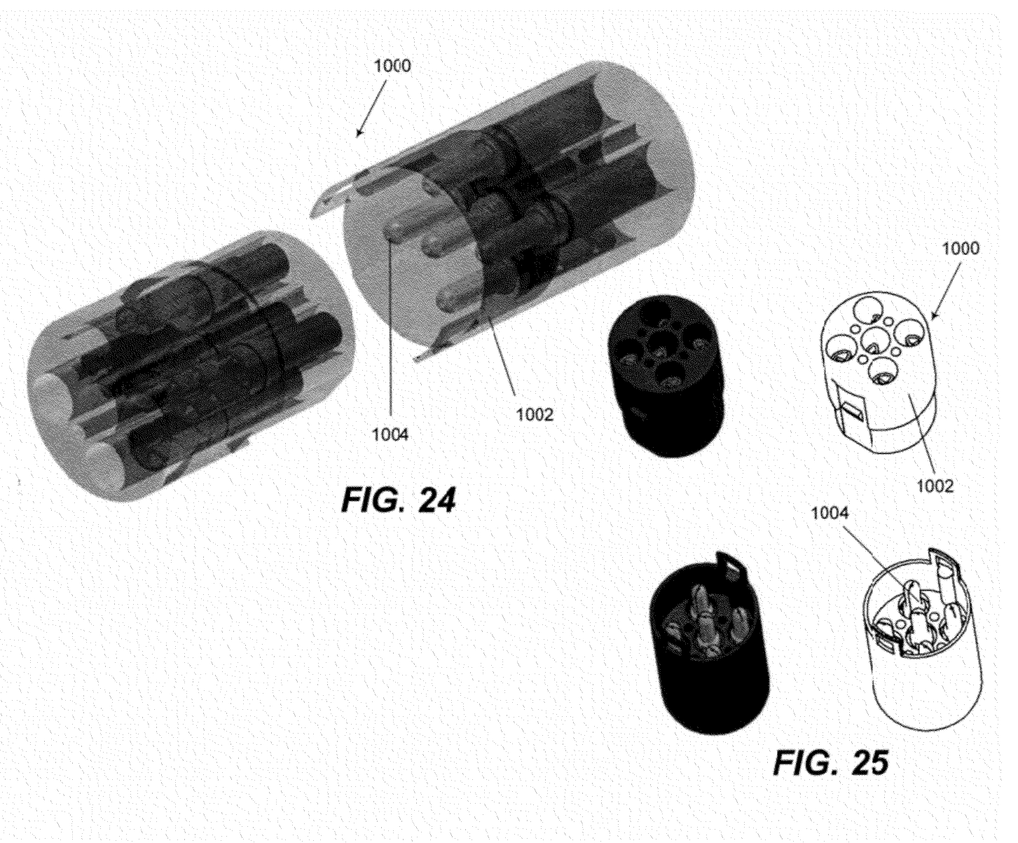

FIG. 18 illustrates another example set of pin connectors according to an embodiment of the invention. In this example, the set of pin connectors is shown in an aligned orientation, and includes a male-type conductor pin 800 and a female-type conductor pin 802. The male-type conductor pin 800 is similar in configuration to the male-type conductor pin in the pin connector set 1004 shown in FIGS. 22-25, and the female-type conductor pin 802 is similar in configuration to the female-type conductor pin in the pin connector set 1004 shown in FIGS. 22-25. The male-type conductor pin 800 in FIG. 18 includes a cylindrical body 804 with a wire receiving end 806 and conductor pin receiving end 808. Between the ends 806, 808, a circumferentially-defined interface 810, a housing retention device 812, and a wire retention device 814 can be formed or otherwise mounted to the male-type conductor pin 800. Likewise, the female-type conductor pin 802 in FIG. 18 includes a cylindrical body 816 with a wire receiving end 818 and conductor pin receiving end 820. Between the ends 818, 820, a circumferentially-defined interface 822, a housing retention device 824, and a wire retention device 826 can be formed or otherwise mounted to the female-type conductor pin 802. One primary difference between the set of pin conductors in FIG. 18 is the relative shapes and sizes of the housing retention devices 812, 824, and wire retention devices 814, 826. The housing retention devices 812, 814 shown in FIG. 18 are slightly smaller than the corresponding housing retention devices in FIGS. 16 and 17. Certain components of the wire retention devices 814, 826 are generally larger than the corresponding wire retention devices in FIGS. 16 and 17. In any instance, the components of the male-type conductor pin 800 and female-type conductor pin 802 shown in FIG. 18 operate in a substantially similar manner as the components of the conductor pins 506, 508 shown in FIGS. 15-17.

FIGS. 19-25 illustrate other example systems and apparatus according to embodiments of the invention. FIGS. 19-21 illustrate one example system and apparatus, and FIGS. 22-25 illustrate another example system and apparatus, in accordance with an embodiments of the invention.

The example system shown in FIG. 19 is a branch wiring connector system 900 with a round-shape housing and apparatus, such as a set of conductor pins, in accordance with an embodiment of the invention. As shown in FIGS. 19-21, the system 900 can include a first housing 902 and a second housing 904, each having one or more conductor holes, such as 906A-906E, at respective opposing ends of the housings 902, 904. The set of conductor pins can include a first conductor pin set 908 mounted to the first housing 902, and a second conductor pin set 910 mounted to the second housing 904. The first conductor pin set 908 can also mount to a corresponding set of wires or conductors, similar to 510 in FIG. 5, inserted through respective conductor holes similar to 906A-906E in one end 912 of the first housing 902. The second conductor pin set 910 can mount to another corresponding set of wires or conductors, similar to 512 in FIG. 5, inserted through respective conductor holes 906 in one end 914 of the second housing 904. For both the first housing 902 and second housing 904, when the sets of wires or conductors are inserted into corresponding conductor holes 906 in each housing, the respective wires or conductors can engage the first conductor pin set 908 and/or the second conductor pin set 910.

As shown in FIGS. 19-21, one or more conductor holes 906 of the first housing 902 and second housing can be uniquely color coded. For example, in the example shown in FIG. 19, an outer conductor hole 906A of the first housing 902 and a corresponding conductor hole of the second housing 904 can be coded with the color white, another conductor hole 906B of the first housing 902 and a corresponding conductor hole of the second housing 904 can be coded with the color black, another conductor hole 906C of the first housing 902 and a corresponding conductor hole of the second housing 904 can be coded with the color red, another conductor hole 906D of the first housing 902 and a corresponding conductor hole of the second housing 904 can be coded with the color blue, and the centrally located conductor hole 1006E of the first housing 1002 and a corresponding centrally located conductor hole of the second housing 1004 can be coded with the color green. In other embodiments, other types of unique codes can be used to facilitate mounting the first housing and second housing together including, but not limited to, tactile indicators, or visual cues.

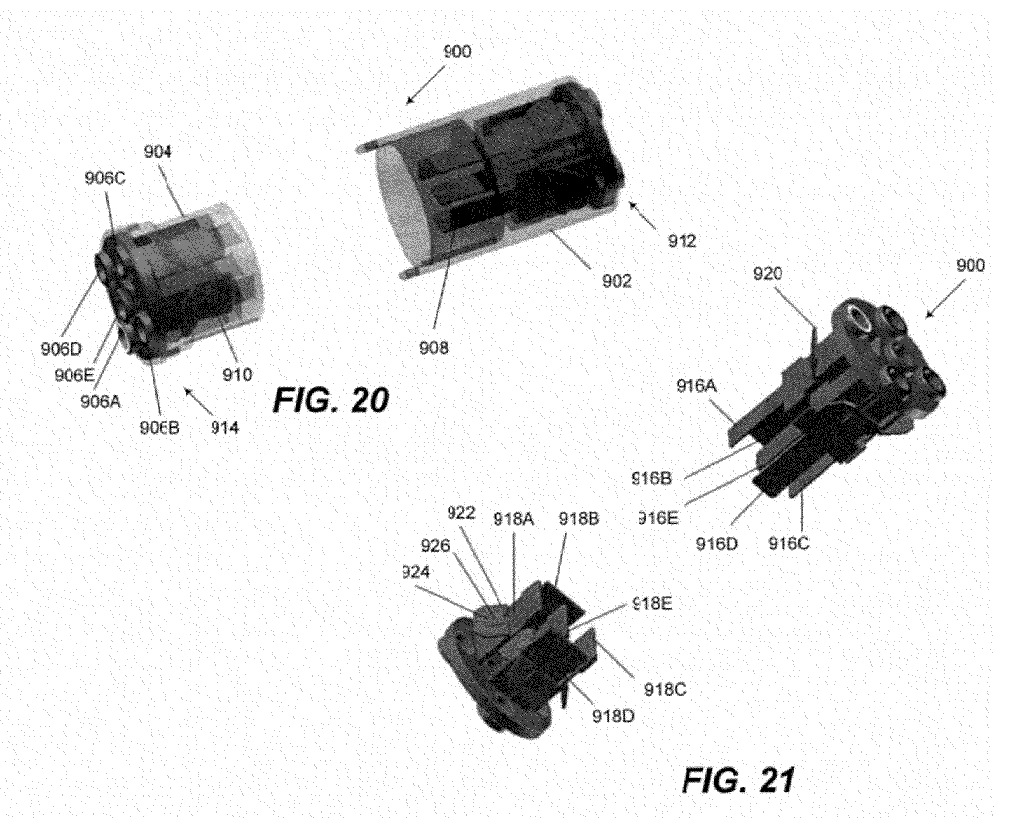

As shown in FIG. 20 with a view through the first housing 902 and second housing 904, the conductor pin sets 908, 910 are mounted to respective portions or opposing ends 912, 914 of the first housing 902 and second housing 904, shown in an aligned orientation. FIG. 21 shows the conductor pin sets 908, 910 shown mounted to opposing end portions 912, 914 of each respective housing 904, 906 with the remaining portions of the respective housings 902, 904 removed for ease of viewing each conductor pin set 908, 910. In the embodiment shown, the conductor pin sets 908, 910 are relatively thin and flat compared to the cylindrically-shaped conductor pins shown in FIGS. 5 and 15-18. The first conductor pin set 908 can include one or more conductor leads 916A-916E, which are relatively wide rectangular-shaped flat prongs. The second conductor pin set 910 can include one or more corresponding conductor leads 918A-918E, which are rectangular-shaped flat prongs. The relatively wide conductor leads 916A-916E of the first conductor pin set 908 can each engage a respective relatively thinner conductor lead 918A-918E of the second conductor set 910 when the first housing 902 and second housing 904 are aligned and manipulated in close proximity and towards each other. Each of the conductor leads 916A-916E, 918A-918E can include a conductor retaining device, such as 920, 922. Each conductor retaining device 920, 922 is operable to prevent or otherwise inhibit an inserted wire or conductor from being withdrawn from contact with the respective conductor lead 916A-916E, 918A-918E. In any instance, the conductor retaining device 920, 922 can maintain the position of the inserted wire or conductor with respect to the respective housing 902, 904, conductor hole, or conductor lead 916A-1916E, 918A-918E.

In this embodiment, the conductor retaining devices 920, 922 can be shaped as rectangular-shaped flat prongs with a centrally positioned hole 924, and the prongs angularly extending away from the respective conductor leads 916A-916E, 918A-918E. Each centrally positioned hole 924 can include a corresponding clip or door 926 attached to each prong, wherein the clip or door 926 can engage an inserted wire or conductor and maintain the position of the wire or conductor with respect to the respective conductor lead 916A-916E, 918A-918E.

In use, the branch wiring connector system 900 and apparatus, such as a set of conductor pins, of FIGS. 19-21 can be selected to engage a pair of corresponding wires or conductors in accordance with an embodiment of the invention. For example, a first wire or conductor, similar to 510 in FIG. 5 can be inserted into an outer conductor hole, similar to 906A, of the first housing 902. Using the similarly coded outer conductor hole of the second housing 904, a user can insert a second wire or conductor, similar to 512 in FIG. 5, into the outer conductor hole, such as 906A, of the second housing 1004. When the wires or conductors are inserted within the holes such as and similar to 906A, the conductor retaining devices, such as 920, 922, can engage the respective wires or conductors. In this manner, each wire or conductor can be mounted to a respective conductor lead, such as 916A, 918A. When the first housing 902 and second housing 904 are mounted together, the first conductor pin set 908 mounts to the second conductor pin set 910, thereby mounting one conductor lead 916A to a corresponding conductor lead 918A to facilitate completion of a branch wiring circuit. In other embodiments, other wires or conductors can be mounted within other respective holes 906B-906E of the second housing 904 and similarly shaped corresponding holes of the first housing 902, and when the first housing 902 and second housing 904 are aligned and mounted together, additional branch wiring circuits can be facilitated.

The example system shown in FIGS. 22-25 is a branch wiring connector system 1000 with a round-shape housing 1002 and apparatus, and a set of round-shape pin connector set 1004, in accordance with an embodiment of the invention. The embodiment shown in FIGS. 22-25 operates similar to those embodiments described above but with a different shape of pin connectors including round-shape male conductors and round-shape female conductors. The round-shape pin connector set 1004 in FIGS. 22-25 is similar to the pin connector set shown and described with respect to FIG. 18.

The example pin conductors and pin conductor receivers described herein can be made from a relatively high copper content alloy. One may recognize that the conductivity of the example pin conductors and pin conductor receivers made in accordance with embodiments of the invention can be further improved by increasing their mass, e.g. adding more metal to the pin conductors and pin conductor receivers, or by selecting materials with relatively high conductivity, e.g., using higher copper content alloys and/or silver plated pins. When both characteristics for pin conductors and pin conductor receivers are increased, that is, increasing mass and increasing the copper alloy content, maintaining a relatively compact, multi-pin connector configuration, such as in the systems described herein, can be achieved in accordance with certain embodiments of the invention. In certain other embodiments, a UL 2459 requirement for maximum temperature rise when subjected to a certain electrical load can be met by example systems described herein.

It will be recognized that systems, apparatus, housings, and connectors in accordance with embodiments of the invention can be made with a variety of durable materials such as plastics, metals, composites, and any combination thereof. It will be further recognized that material selection for compatibility with the application, the housing and connector components can be controlled. It will be appreciated that while the specification describes certain shapes, configurations, and orientations of an example system with a first housing and a second housing, there may, in certain other embodiments, be different shaped housings with the same, similar, or different components having the same, similar, or different shapes, configurations and/or orientation without departing from example embodiments of the invention. Other system, apparatus, and housing and connector embodiments in accordance with the invention can include fewer or greater numbers of components and may incorporate some or all of the functionality described with respect to the system, apparatus, and housing and connector components shown in FIGS. 5-25.

One skilled in the art may recognize the applicability of these housing and connector components in certain embodiments of the invention to other environments, contexts, and applications. One will appreciate that the housing and connector components shown in and described with respect to FIGS. 5-25 are provided by way of example only. Numerous other operating environments, systems, apparatus, housing, and connectors are possible using these or similar housing, and connector components. Accordingly, these housing, and connector components should not be construed as being limited to any particular operating environment, system, apparatus, or housing and connector configuration.

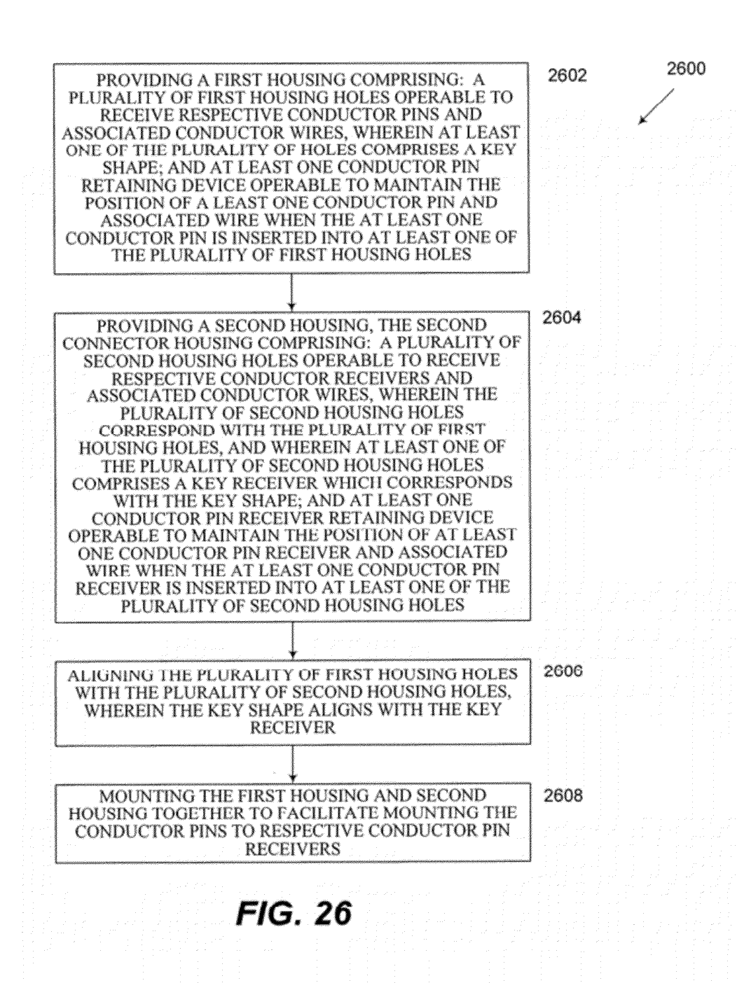

Example methods and processes which can be implemented with the example systems, apparatus, and components of FIGS. 5-25 are described by reference to FIG. 26. FIG. 26 illustrates a flowchart of an example method according to one embodiment of the invention. The method 2600 described in FIG. 26 is a method for connecting conductors in a branch wiring circuit.

The method 2600 begins at block 2602, wherein a first housing is provided. The first housing can include a plurality of first housing hole projections operable to receive respective conductor pins and associated conductor wires, wherein at least one of the plurality of first housing hole projections comprises a key shape. Furthermore, the first housing can include at least one conductor pin retaining device operable to maintain the position of a least one conductor pin and associated wire when the at least one conductor pin is inserted into at least one of the plurality of first housing hole projections provided.

Block 2602 is followed by block 2604, in which a second housing is provided. The second housing can include a plurality of second housing holes operable to receive respective conductor receivers and associated conductor wires, wherein the plurality of second housing holes correspond with the plurality of first housing hole projections, and wherein at least one of the plurality of second housing holes comprises a key receiver which corresponds with the key shape. The second housing can also include at least one conductor pin receiver retaining device operable to maintain the position of at least one conductor pin receiver and associated wire when the at least one conductor pin receiver is inserted into at least one of the plurality of second housing holes.

Block 2604 is followed by block 2606, in which the plurality of first housing hole projections is aligned with the plurality of second housing holes, wherein the key shape aligns with the key receiver.

Block 2606 is followed by block 2608, in which the first housing and second housing are mounted together to facilitate mounting the conductor pins to respective conductor pin receivers.

In one aspect of an embodiment, a key shape can include one of the following: a teardrop shape, or a protrusion.

In one aspect of an embodiment, the method can further include inserting the first housing or the second housing within a standard ½ inch size knockout of an electrical junction box.

In one aspect of an embodiment, the first housing and the second housing can include one or more of the following to facilitate mounting the first housing and second housing together: color codes, tactile indicators, or visual cues.

In one aspect of an embodiment, the at least one conductor pin retaining device or the at least one conductor pin receiver retaining device can include a restrictor section mounted within a respective first mounting hole or second mounting hole, wherein the restrictor section engages one or more protrusions from the respective conductor pin or conductor pin receiver.

In one aspect of an embodiment, the method can include providing a conductor pin operable to mount to an end of a first electrical conductor, and further operable to be inserted into at least one of the plurality of first housing hole projections; and providing a conductor pin receiver operable to mount to an end of a second electrical conductor, and further operable to be inserted into at least one of the plurality of second housing holes, wherein the conductor pin and conductor pin receiver mount together when the first housing and second housing are mounted together and the plurality of first housing hole projections are in correspondence with the plurality of second housing holes.

In one aspect of an embodiment, the first housing can further include an engagement device complementary with a corresponding engagement device of the second housing, wherein when the first housing and second housing are mounted together in close proximity the engagement device of the first housing and corresponding engagement device of the second housing maintain the respective positions of the first housing and second housing

After block 2608, the method 2600 ends.

Additionally, it is to be recognized that, while the invention has been described above in terms of one or more embodiments, it is not limited thereto. Various features and aspects of the above described invention may be used individually or jointly. Although the invention has been described in the context of its implementation in certain environments and for certain purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every element described and illustrated need be performed. Accordingly, the claims set forth below should be construed in view of the full breadth of the embodiments as disclosed herein.

The claimed invention is:

1. A branch wiring connector system comprising:
a first housing comprising:
a plurality of first housing hole projections operable to receive respective conductor pins and associated conductor wires, wherein at least one of the plurality of hole projections comprises a key shape;
at least one conductor pin retaining device operable to maintain the position of a least one conductor pin and associated wire when the at least one conductor pin is inserted into at least one of the plurality of first housing hole projections; and
a second housing comprising:
a plurality of second housing holes operable to receive respective conductor receivers and associated conductor wires, wherein the plurality of second housing holes correspond with the plurality of first housing hole projections, and wherein at least one of the plurality of second housing holes comprises a key receiver which corresponds with the key shape;
at least one conductor pin receiver retaining device operable to maintain the position of at least one conductor pin receiver and associated wire when the at least one conductor pin receiver is inserted into at least one of the plurality of second housing holes,
wherein the first housing and second housing mount together to facilitate mounting the conductor pins to respective conductor pin receivers when the plurality of first housing hole projections are in correspondence with the plurality of second housing holes.

2. The system of claim 1, wherein the key shape comprises one of the following: a teardrop shape, or a protrusion.

3. The system of claim 1, wherein the system meets or exceeds at least one of the following UL listing requirements: short-time withstand current, latching mechanism, abnormal overload, temperature rise, dielectric voltage withstand, dielectric withstand—puncture, mold stress relief, current cycling, mechanical sequence, spring action, or any UL listing requirement specified under UL 2459.

4. The system of claim 1, wherein the first housing or the second housing fits within a standard ½ inch size knockout of an electrical junction box.

5. The system of claim 1, wherein the first housing and the second housing comprise one or more of the following to facilitate mounting the first housing and second housing together: color codes, tactile indicators, or visual cues.

6. The system of claim 1, wherein the at least one conductor pin retaining device or the at least one conductor pin receiver retaining device comprise a restrictor section mounted within a respective first mounting hole or second mounting hole, wherein the restrictor section engages one or more protrusions from the respective conductor pin or conductor pin receiver.

7. The system of claim 1, further comprising:
a conductor pin operable to mount to an end of a first electrical conductor, and further operable to be inserted into at least one of the plurality of first housing hole projections; and
a conductor pin receiver operable to mount to an end of a second electrical conductor, and further operable to be inserted into at least one of the plurality of second housing holes,
wherein the conductor pin and conductor pin receiver mount together when the first housing and second housing are mounted together and the plurality of first housing hole projections are in correspondence with the plurality of second housing holes.

8. The system of claim 1, wherein the first housing further comprises an engagement device complementary with a corresponding engagement device of the second housing, wherein when the first housing and second housing are mounted together in close proximity the engagement device of the first housing and corresponding engagement device of the second housing maintain the respective positions of the first housing and second housing.

9. A method for connecting conductors in a branch wiring circuit, the method comprising:
providing a first housing comprising:
a plurality of first housing hole projections operable to receive respective conductor pins and associated conductor wires, wherein at least one of the plurality of first housing hole projections comprises a key shape;
at least one conductor pin retaining device operable to maintain the position of a least one conductor pin and associated wire when the at least one conductor pin is inserted into at least one of the plurality of first housing hole projections; and
providing a second housing comprising:
a plurality of second housing holes operable to receive respective conductor receivers and associated conductor wires, wherein the plurality of second housing holes correspond with the plurality of first housing hole projections, and wherein at least one of the plurality of second housing holes comprises a key receiver which corresponds with the key shape;
at least one conductor pin receiver retaining device operable to maintain the position of at least one conductor pin receiver and associated wire when the at least one conductor pin receiver is inserted into at least one of the plurality of second housing holes,
aligning the plurality of first housing hole projections with the plurality of second housing holes, wherein the key shape aligns with the key receiver; and
mounting the first housing and second housing together to facilitate mounting the conductor pins to respective conductor pin receivers.

10. The method of claim 9, wherein the key shape comprises one of the following: a teardrop shape, or a protrusion.

11. The method of claim 9, further comprising:
inserting the first housing or the second housing within a standard ½ inch size knockout of an electrical junction box.

12. The method of claim 9, wherein the first housing and the second housing comprise one or more of the following to facilitate mounting the first housing and second housing together: color codes, tactile indicators, or visual cues.

13. The method of claim 9, wherein the at least one conductor pin retaining device or the at least one conductor pin receiver retaining device comprise a restrictor section mounted within a respective first mounting hole or second mounting hole, wherein the restrictor section engages one or more protrusions from the respective conductor pin or conductor pin receiver.

14. The method of claim 9, further comprising:
providing a conductor pin operable to mount to an end of a first electrical conductor, and further operable to be inserted into at least one of the plurality of first housing hole projections; and
providing a conductor pin receiver operable to mount to an end of a second electrical conductor, and further operable to be inserted into at least one of the plurality of second housing holes,
wherein the conductor pin and conductor pin receiver mount together when the first housing and second housing are mounted together and the plurality of first housing hole projections are in correspondence with the plurality of second housing holes.

15. The method of claim 9, wherein the first housing further comprises an engagement device complementary with a corresponding engagement device of the second housing, wherein when the first housing and second housing are mounted together in close proximity the engagement device of the first housing and corresponding engagement device of the second housing maintain the respective positions of the first housing and second housing.

16. An electrical connector system comprising:
a first housing comprising:
a plurality of first housing hole projections operable to receive respective conductor pins and associated conductor wires, wherein at least one of the plurality of first housing hole projections comprises a key shape comprising one of the following: a teardrop shape, or a protrusion;
at least one conductor pin retaining device operable to maintain the position of a least one conductor pin and associated wire when the at least one conductor pin is inserted into at least one of the plurality of first housing hole projections;
a second housing comprising:
a plurality of second housing holes operable to receive respective conductor receivers and associated conductor wires, wherein the plurality of second housing holes correspond with the plurality of first housing hole projections, and wherein at least one of the plurality of second housing holes comprises a key receiver which corresponds with the key shape;
at least one conductor pin receiver retaining device operable to maintain the position of at least one conductor pin receiver and associated wire when the at least one conductor pin receiver is inserted into at least one of the plurality of second housing holes,
wherein the first housing and second housing mount together when the plurality of first housing holes are in correspondence with the plurality of second housing holes;
a conductor pin operable to mount to an end of a first electrical conductor, and further operable to be inserted into at least one of the plurality of first housing hole projections; and
a conductor pin receiver operable to mount to an end of a second electrical conductor, and further operable to be inserted into at least one of the plurality of second housing holes,
wherein the conductor pin and conductor pin receiver mount together when the first housing and second housing are mounted together and the plurality of first housing hole projections are in correspondence with the plurality of second housing holes.

17. The system of claim 16, wherein the system meets or exceeds at least one of the following UL listing requirements: short-time withstand current, latching mechanism, abnormal overload, temperature rise, dielectric voltage withstand, dielectric withstand—puncture, mold stress relief, current cycling, mechanical sequence, spring action, or any UL listing requirement specified under UL 2459.

18. The system of claim 16, wherein the first housing or the second housing fits within a standard ½ inch size knockout of an electrical junction box.

19. The system of claim 16, wherein the first housing and the second housing comprise one or more of the following to facilitate mounting the first housing and second housing together: color codes, tactile indicators, or visual cues.

20. The system of claim 16, wherein the first housing further comprises an engagement device complementary with a corresponding engagement device of the second housing, wherein when the first housing and second housing are mounted together in close proximity the engagement device of the first housing and corresponding engagement device of the second housing maintain the respective positions of the first housing and second housing.

21. A branch wiring connector system comprising:
a first housing comprising:
a plurality of first housing hole projections operable to receive respective conductor wires, wherein at least one of the plurality of first housing hole projections comprises a first housing code;
at least one conductor wire retaining device operable to maintain the position of a least one conductor wire when the at least one conductor wire is inserted into at least one of the plurality of first housing hole projections; and
a second housing comprising:
a plurality of second housing holes operable to receive other respective conductor wires, wherein the plurality of second housing holes correspond with the plurality of first housing holes, and wherein at least one of the plurality of second housing holes comprises a second housing code which corresponds with the first housing code;
wherein the first housing and second housing mount together to facilitate mounting the conductor wires to the other respective conductor wires when the plurality of first housing hole projections are in correspondence with the plurality of second housing holes.
